(19) United States
(12) Patent Application Publication
(10) Pub. No.: US 2002/0007447 A1
(43) Pub. Date: Jan. 17, 2002

(54) Assembled-type backup apparatus using hard disk drives

(75) Inventor: Shinichiro Oue, Tokyo (JP)

Correspondence Address: SUGHRUE, MION, ZINN, MACPEAK & SEAS, PLLC, 2100 Pennsylvania Avenue, N.W., Washington, DC, 20037-3202, US

(73) Assignee: NEC CORPORATION

(21) Appl. No.: 09/903,730

(22) Filed: Jul. 13, 2001

(30) Foreign Application Priority Data
Jul. 17, 2000 (JP) 2000-216474

(51) Int. Cl. G06F 12/16

(52) U.S. Cl. 711/162; 711/114

(57) ABSTRACT

There is provided an inexpensive, high performance assembled-type backup apparatus using hard disks which ensures safety of backup data with such a simple configuration as to select a specific HDD at the time of drive access, and which can be decreased in power consumption. The apparatus includes HDD selecting means for activating only a specific hard disk drive from among a plurality of hard disk drives.

### BACKGROUND OF THE INVENTION

1. Field of the Invention

The present invention relates to an assembled-type backup apparatus using a plurality of hard disk drives (hereafter referred to as HDDs).

2. Description of the Related Art

In the conventional backup apparatuses using hard disk drives, there are an apparatus having an array configuration in order to ensure data reliability, and an apparatus simply linking a plurality of HDDs for the purpose of lowering the cost.

However, the conventional backup apparatus using HDDs has the following problems. In other words, in the apparatus having an array configuration of HDDs, it is necessary to use an expensive array board and a large capacity power supply for supplying supply power to all hard disk drives, so that an inexpensive system cannot be provided.

On the other hand, in such a system that a plurality of HDDs are simply connected, the array board is not necessary, but power supply must still be supplied to all drives, and consequently a large capacity power supply becomes necessary. Furthermore, although the manufacturing cost of the above-mentioned apparatus becomes lower as compared with that of the apparatus having the array configuration, this system remains the same as the exterior type HDDs and safety of backup data cannot be ensured.

### SUMMARY OF THE INVENTION

An object of the present invention is to provide an inexpensive, high performance assembled-type backup apparatus having a plurality of hard disks which ensure safety of backup data with such a simple configuration as to select a specific HDD at the time of drive access, and which can be decreased in power dissipation. In other words, the present invention attempts to provide an inexpensive backup apparatus using HDDS, which are available at the lowest manufacturing cost, as backup media in small and medium-size PC server systems. Furthermore, in small-sized backup systems, the present invention attempts to form a backup apparatus by using HDDs, which is more inexpensive in price per bit than magnetic tapes and provide a simple and high performance HDD backup apparatus to PC users.

In order to achieve the above described object, a backup apparatus according to the present invention comprising, a plurality of hard disk drives, and an HDD selecting means for selecting only a specific hard disk drive from among the plurality of hard disk drives, the HDD selecting means controlling to connect a power supply line and a data bus to said selected hard disk drive so as to activate thereof.

By such a configuration, one drive is basically in operation irrespective of the number of mounted HDDs. Therefore, the power supply capacity can be made small, and the power dissipation can be reduced. Furthermore, since there is no need to use an expensive apparatus such as a disk array, the manufacturing cost can be reduced. In addition, since hard disk drives which are not activated are disconnected from the system and come in the pause state, as a result, shock resistance is increased, and a data loss due to operation mistake is avoided. In addition, by stopping the HDDs and disconnecting them from the system except during the time of data access, power consumption can be saved and data destruction caused by unexpected access or shock can be suppressed to the minimum.

The present invention regards a single HDD as a magnetic tape medium. A backup apparatus according to the present invention has an HDD selecting means including a switch and two or more HDDs as backup media, and activates only one HDD selected by the HDD selecting means from among two or more mounted HDDS. A drawback concerning reliability in a backup apparatus using a single HDD is thus eliminated.

The HDD selecting means may have such a configuration as to convert a SCSI (Small Computer System Interface) signal from a high order apparatus to an ATA (AT Attachment) signal and control a selected HDD. Furthermore, the HDD drive may be a SCSI type.

Preferably, the apparatus of the present invention has a function of monitoring a state of the HDDs, and it periodically detects whether or not there is an abnormality in the HDDS. In addition, an assembled-type backup apparatus according to the present invention further comprising a monitoring means for monitoring a state of each hard disk drive and indicating a monitoring result of each hard disk drive.

This monitoring is conducted basically for each HDD. If there is an abnormality, the indicator section indicates to notify the user of it. Based on the monitor information obtained by periodic self-test conducted by the switchboard section, the indicator section indicates whether there is an abnormality in each HDD.

Furthermore, the HDD selecting means may have a switch so as to select and activate two or more hard disks simultaneously. By providing two or more activated drives with a mirror configuration, higher reliability can be obtained.

Furthermore, if a hard disk drive is manually selectable, the system can be started up from an arbitrary HDD from among HDDs mounted on the apparatus. As a result, recovery from a system trouble can be conducted more easily.

### BRIEF DESCRIPTION OF THE DRAWINGS

FIG. 1(a) is an exterior oblique view of the assembled-type backup apparatus of the present invention.

FIG. 1(b) is a front view of the assembled-type backup apparatus of the present invention.

FIG. 1(c) is a top view showing an internal configuration of FIG. 1.

FIG. 1(d) is a side view showing the internal configuration of FIG. 1.

FIG. 2 is a diagram showing a detailed internal configuration of the backup apparatus of FIG. 1.

### DESCRIPTION OF THE PREFERRED EMBODIMENTS

Embodiments of the present invention are described in detail below, with references made to relevant accompanying drawings.

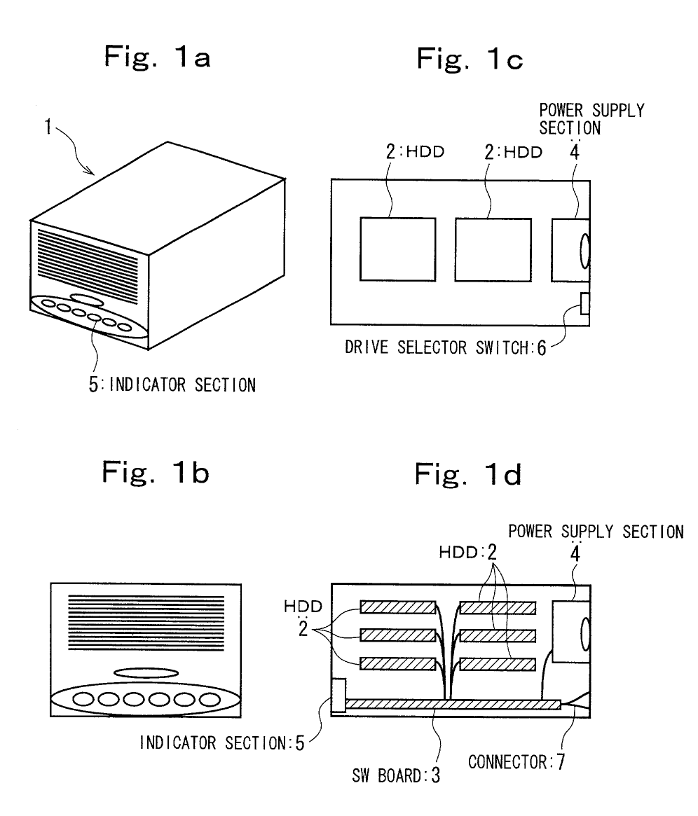

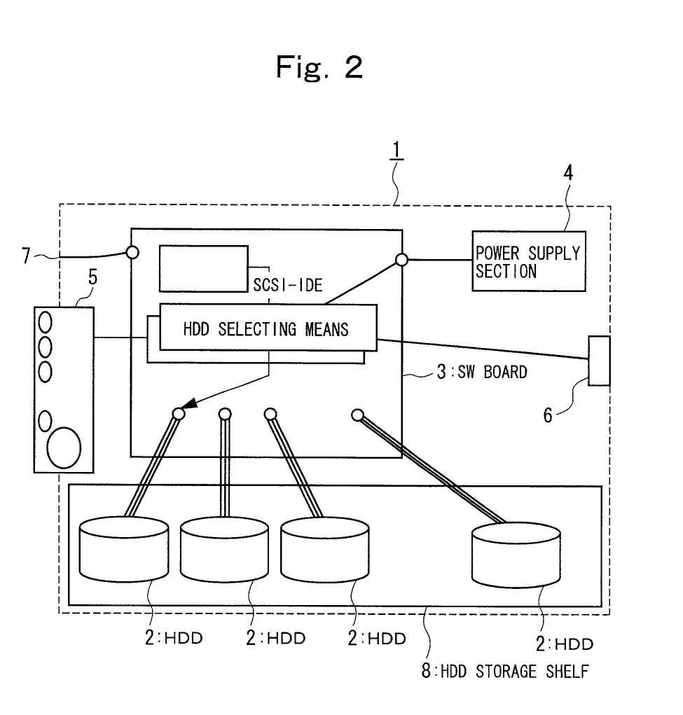

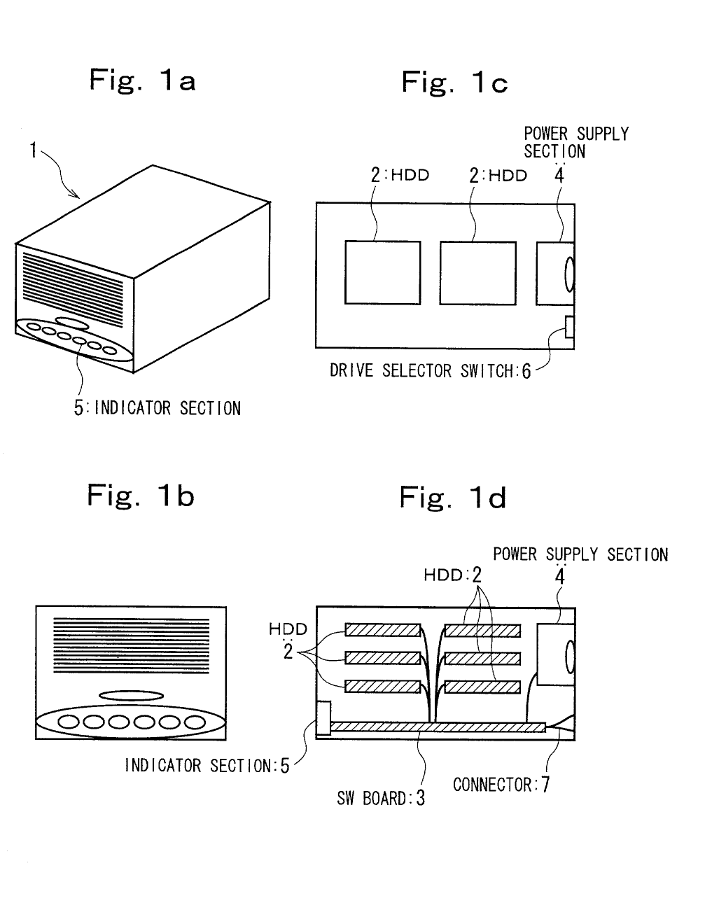

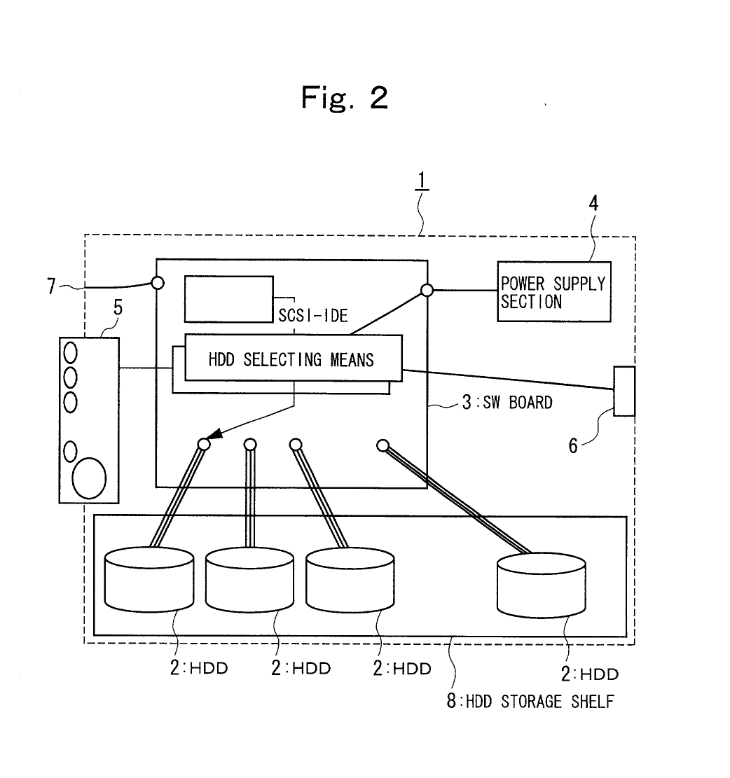

FIGS. 1 and 2 are drawings showing an entire configuration of a hard disk autoloader 1 serving as an assembled-type backup apparatus using hard disks according to the present invention. This hard disk autoloader 1 includes a plurality of HDDs 2, 2, . . . , a switchboard 3 having an HDD selecting means for selecting and activating only a specific HDD 2 among a plurality of HDDS, a power supply section 4 connected to the switchboard 3 for supplying power to HDDs 2, an indicator section 5 connected to the switchboard 3 so as to indicate states of the HDDs 2, a boot drive setting switch 6, and a connector 7 for supplying a control signals from a high order apparatus of the assembled-type backup apparatus of the present invention and supplying a power supply to selected HDDs via the switchboard 3.

The switchboard 3 selects one HDD from among a plurality of HDDs 2 mounted on the autoloader 1, conducts connection changeover of a data bus and a power supply line, and supplies data and power to the selected HDD 2. The above-mentioned connection changeover is conducted by the control signals output from the high order apparatus of the assembled-type backup apparatus of the present invention.

The switchboard 3 has the following functions:

1. Changeover function of mounted HDD:

Connections of power supply line and data bus of the HDDs 2, 2, . . . is switched over in response to the control signals output from the high order apparatus of the assembled-type backup apparatus of the present invention.

2. SCSI to ATA conversion function:

This function becomes necessary when using an ATA-type HDD.

3. Monitoring function of HDDs 2:

This function periodically (once/day or more) monitors about whether there are any abnormalities in HDDs, and the monitoring results are displayed on the indicator section 5. In the startup step of HDDs as well, this work is conducted. The indicator section 5 is mounted on the switch board 3, and an indicator lamp for indicating the state of each HDD is provided.

4. HDD 2 selection function:

A HDD 2 is selected based on the setting of the boot drive setting switch 6.

The power supply section 4 supplies power to the selected HDD 2 and its control circuit board via the switch board 3.

The indicator section 5 indicates a state of each of mounted HDDs 2, which is output from the switchboard 3, by using a red/green LED, and notifies the user whether there is an abnormality in each HDD 2.

The HDDs 2 are installed on a storage shelf 8 in the apparatus (see FIG. 2). Power is supplied to only one HDD 2 selected by the switchboard 3, and a data bus coupled to a high order apparatus is connected thereto. As a result, the selected HDD 2 is recognized by the high order apparatus. By the way, the storage shelf 8 has such a structure as to facilitate maintenance so as to facilitate failure replacement of the HDDs 2.

The configuration of the present embodiment has been heretofore described in detail. However, since the SCSI to ATA conversion function and the structure of the HDD storage shelf are well known to those skilled in the art and they do not have a direct relation to the present invention, description of their detailed configuration will be omitted. In the above described embodiment, only one HDD is selected. However two or more HDDs 2 which comprises the mirror configuration may be activated at the same time. Furthermore, as for HDDs 2, the SCSI type may also be used instead of the ATA type.

A second embodiment of a backup apparatus according to the present invention will now be described. In the second embodiment, the above described boot drive setting switch 6 can be set to 0 (automatic startup), or 1 to n (manually setting the predetermined hard disk drive, where n is the number of HDDs) . By such a configuration, it becomes possible to manually select a HDD in the startup step. As a result, it is possible to select an arbitrary HDD from among HDDs mounted on the autoloader 1 and start the system. Accordingly, recovery from a system trouble can be conducted more easily.

Furthermore, by utilizing this function, the present apparatus can be used not only as a backup apparatus, but also as a system for providing a multi-system in which respective HDDs are switched over and used.

As heretofore described, the present invention brings about the following effects.

First, since a hard disk drive is used as a medium of the backup apparatus, the backup apparatus of the present invention has a data transfer characteristics which is very fast as compared with a conventional backup apparatus using an MT device. As a result, backup work can be conducted in a short time.

Secondly, since a specific hard drive is selectively activated by HDD selecting means, a power supply having a small capacity can be used irrespective of the number of mounted hard disk drives, and the power consumption can be reduced.

Thirdly, hard disk drives which are not being used are brought into the pause state, thereby improved shock resistance can be anticipated.

What is claimed is:

1. An assembled-type backup apparatus comprising,
a plurality of hard disk drives, and
an HDD selecting means for selecting only a specific hard disk drive from among said plurality of hard disk drives, said HDD selecting means controlling to connect a power supply line and a data bus to said selected hard disk drive so as to activate thereof.

2. An assembled-type backup apparatus according to claim 1, wherein said HDD selecting means selects a hard disk drive based on a control signal output from a high order apparatus of said backup apparatus.

3. An assembled-type backup apparatus according to claim 1, wherein said HDD selecting means selects a plurality of hard disk drives based on a control signal output from a high order apparatus of said backup apparatus.

4. An assembled-type backup apparatus according to claim 1, wherein said HDD selecting means further comprising a switch for selecting a hard disk drive.

5. An assembled-type backup apparatus according to claim 1, wherein said HDD selecting means further comprising a switch for selecting a hard disk drive manually.

6. An assembled-type backup apparatus according to claim 1, wherein said backup apparatus further comprising a monitoring means for monitoring a state of each hard disk drive and indicating a monitoring result of each hard disk drive.
